(19) United States
(12) Patent Application Publication
(10) Pub. No.: US 2004/0086227 A1
(43) Pub. Date: May 6, 2004

(54) Arbitrary filter shape tuning methods of long-period fiber gratings based on divided coil heater

(75) Inventors: Jun-Kye Bae, Seoul (KR); Sang-Hyuck Kim, Seoul (KR); Je-Myung Jeong, Seoul (KR); Sang-Bae Lee, Seoul (KR)

Correspondence Address: MORRISON & FOERSTER LLP, 1650 TYSONS BOULEVARD, SUITE 300, MCLEAN, VA, 22102, US

(73) Assignee: Korea Institute of Science and Technology, Seoul (KR)

(21) Appl. No.: 10/437,250

(22) Filed: May 14, 2003

(30) Foreign Application Priority Data
Oct. 30, 2002 (KR) 66644/2002

(51) Int. Cl. G02B 6/34

(52) U.S. Cl. 385/37

(57) ABSTRACT

Disclosed is an optical fiber grating comprising: optic fiber having periodically formed gratings; and a temperature control method for independently controlling temperature along grating sections. In the optical fiber, the temperature is controlled along grating sections, the desired spectrum can be obtained by varying the refractive index of each unit section, and the fiber gratings can be applied to various optical communication devices.

### BACKGROUND OF THE INVENTION

1. Field of the Invention

The present invention relates to optical fiber gratings, and more particularly, to an optical fiber gratings which can change the refractive index by controlling the temperature distribution along grating sections.

2. Description of the Related Art

Generally, optical fiber gratings designate optical fiber devices which consist of the periodic modulation of the refraction index along the fiber core. Optical fiber gratings are fabricated by exposing an optical fiber to the periodic pattern of ultraviolet intensity. Optical fiber gratings are simply optical diffraction gratings and couple one of incident mode on the optical gratings to other modes.

Advantages of optical fiber gratings include all-fiber geometry, low insertion loss, high extinction ratio, and potentially low cost. But the most distinguishable feature of optical fiber gratings is the flexibility to achieve the desired spectral characteristics.

As WDM has been more important in optical fiber communications, optical fiber gratings have become the key components for various kinds of devices such as gain equalizers of the optical fiber amplifier, band-rejection filters, WDM isolation fiber filters, and thermal or strain sensors.

FIG. 1 is a mimetic diagram showing a part of optical fiber gratings, in which gratings 12 are formed on a core of an optical fiber 10. Optical fiber gratings can be generally classified into two types: Bragg gratings (also called reflection and short-period gratings), in which the coupling occurs between modes traveling in opposite directional and transmission gratings (also called long-period fiber gratings), which the coupling occurs between modes traveling in the same direction.

Long-period fiber gratings with periodicities in the hundreds of microns can include the coupling of the guided fundamental mode in a single-mode fiber to forward-propagating cladding modes. These cladding modes decay rapidly as they propagate along the fiber owing to scattering losses at the cladding-air interface and bend in the fiber.

In long-period fiber gratings, the coupling of the core mode into the cladding mode occurs in a very wide region (several tens of nm) and a reflected core mode does not exist. Also, the coupling is very sensitively changed by externally applied bend, strain, temperature change, and etc. The characteristics of long-period gratings can be useful for band rejection filters to remove ASE in Er-doped fiber amplifier (EDFA), gain flattening filters, mode converters, temperature/strain/refractive index sensors, and etc.

Long-period fiber gratings have been used as the band rejection filters for gain-flattening of EDFA due to their wide bandwidth over several tens of nm and the cladding leaky mode characteristics. However, since the spectrum of long-period gratings is symmetrical on the basis of a central wavelength, it is difficult to fabricate an arbitrary loss curve shape for the gain-flattening of EDFA and to synthesize the desired spectrum of filters precisely. Since the filter characteristics can be also changed by the length of EDF and the pumping source intensity, the characteristics of the band rejection filters should be desirably controlled in order to satisfy the various filtering demand conditions.

### SUMMARY OF THE INVENTION

Therefore, an object of the present invention is to provide an optical fiber grating which can precisely control its spectrum to extremely extend its applications to various optical fiber devices.

To achieve these and other advantages in accordance with the purpose of the present invention, as embodied and broadly described herein, it is provided an optical fiber gratings comprising: optic fiber having periodically formed gratings; and a temperature control means for independently controlling temperature of the optical fiber along grating sections.

The foregoing and other objects, features, aspects and advantages of the present invention will become more apparent from the following detailed description of the present invention in conjunction with the accompanying drawings.

### BRIEF DESCRIPTION OF THE DRAWINGS

The accompanying drawings illustrate the embodiments of the invention and the description to explain the principles of the invention.

In the drawings:

FIG. 1 is a mimetic diagram showing the schematics of optical fiber with the grating formation;

FIG. 2 is a mimetic diagram showing the schematics of the filter with a multiport lattice structure to analyze long-period fiber gratings of the present invention;

FIG. 3A is a mimetic diagram showing optical fiber gratings filter of the present invention;

FIG. 3B is a partial enlargement view of FIG. 3A;

FIG. 4 is a graph showing a transmission spectrum of a filter which is controlled by heat so as to achieve a desired value;

FIG. 5 is a graph showing a test result of tuning the gain flattening filter of EDFA.

FIG. 6 is a distribution chart of heat applied to each section for controlling long-period fiber gratings;

FIG. 7 is a picture showing an example of the optical fiber grating and divided coil heater actually fabricated according to the present invention.

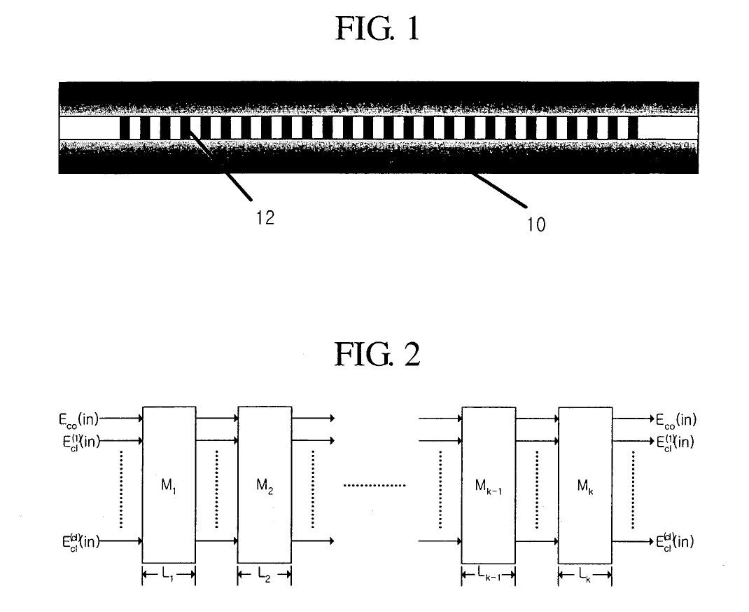

### DETAILED DESCRIPTION OF THE PREFERRED EMBODIMENTS

Reference will now be made to the preferred embodiments of the present invention, as illustrated in the accompanying drawings.

Characteristics of band rejection filters using the optical fiber gratings according to the present invention can be controlled by individually tunable heaters.

Long-period fiber gratings couple a guided fundamental mode in a single-mode fiber to forward propagation cladding modes by a periodic refractive index change of a core and thus the core mode in a certain wavelength decays rapidly as it propagates along the fiber. Since the coupling is wavelength-dependent, fiber gratings act as wavelength-dependent loss elements. To get a better controllability of frequency response, the concatenated structure with several long-period fiber gratings are usually used. In concatenated long-period fiber gratings, there exist a single fundamental core mode LP₀₁ and multiple cladding modes (LP₀₁, LP₀₂, . . . LP_{0P}), which propagate in the same forward direction. The interaction between the amplitude envelope Λ_{co}(z) of the core mode and the amplitude envelopes Λ^{el}^{(p)}(z) of cladding modes in a single uniform-grating (location between z=0 and z=1) can be represented by a set of P independent coupled mode equations.

$$\begin{matrix}\frac{ⅆ {A}_{co}^{( p )} ( z )}{ⅆ z} = - j {κ}_{p} {A}_{cl}^{( p )} ( z ) {ⅇ}^{j 2 {δ}_{p} z} , \\ \frac{ⅆ {A}_{cl}^{( p )} ( z )}{ⅆ z} = - j {κ}_{p} {A}_{co}^{( p )} ( z ) {ⅇ}^{- j 2 {δ}_{p} z} ,\end{matrix} p = 1 , 2 , … P$$

with A_{co}(L) given by

$${A}_{co}^{( p )} ( L ) = {\prod }_{p = 1}^{P} {A}_{co}^{( p )} ( L ) .$$

wherein the detuning δₚ is a function of λ, \overline{n}_{eff} and Λ. The coupling coefficient Kₚ is a function of \overline{n}_{off}. The δₚ and Kₚ can be controlled by the grating strength, \overline{n}_{off}, and the grating period Λ and thereby the filter characteristics of the optical fiber grating can be controlled.

Materials constituting the optical fiber such as GeO₂, SiO₂, F/SiO₂, and B₂O₃ have the refractive indices which can be changed by temperature. Based on this mechanism, the effective refractive index of optical fiber gratings can be changed.

In the present invention, by using the independent temperature control methods along grating sections, the spectral shape of long-period fiber gratings can be effectively controlled like the concatenated long-period fiber grating with the different refractive indices, Based on this principle, the desired wavelength and spectrum can be obtained. FIG. 2 is a mimetic diagram showing the long-period gratings filter connected in serial by a multiport lattice structure.

In FIG. 2, a core mode field E_{co}(in) and a cladding mode field Eₑₗ^{(p)}(in) passing through a grating section Mₖ are coupled to each grating section, and can be written as R_{co}(out) and Eₑₗ^{(p)}(out) consequently.

In the temperature control methods of the present invention, the separated coil heater wound along the grating sections of the optical fiber was used. The coil heater independently generates heat with a control signal of a unit section and thus controls the temperature distribution via each section of the optical fiber on which the coil is wound.

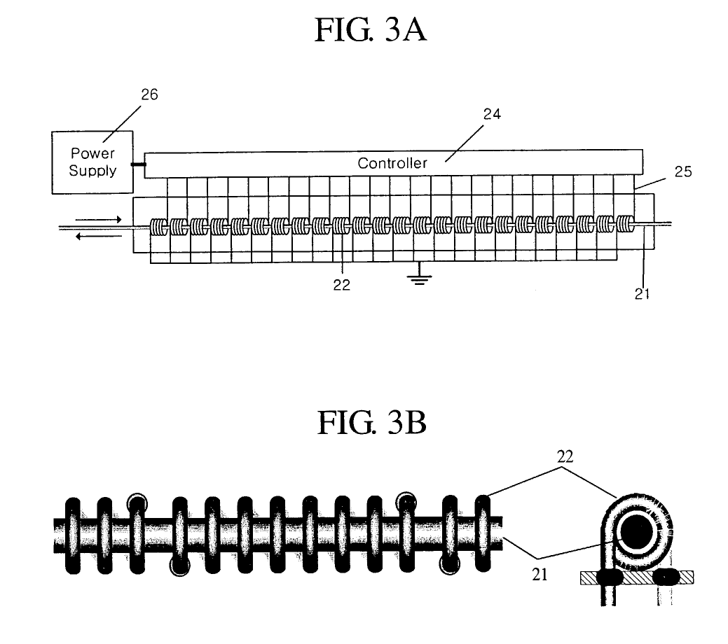

FIG. 3A is a mimetic diagram showing optical fiber gratings and divided coil heater of the present invention. Referring to FIG. 3A, the coil heater is wound on optical fiber gratings. The coil heater 22 is separately arranged by each section of the optical fiber 21, and long-period gratings are inserted in the coil heater. The coil heater is composed of the control unit 25 through a connecting unit 24, thereby controlling the heat generation along each section. A reference numeral 26 denotes a power source unit for supplying a power to a control unit.

FIG. 3B is a partial enlargement view of FIG. 3A, which shows the coil 22 wound one section of the optical fiber 21. The coil heater used in the preferred embodiment is divided into 32 sections thus to control the respective long-period grating sections. Each of heater sections is formed by winding Ni—Cr line with a diameter of 120 μm eight times. The length and inner diameter of the coil heater were 1800 μm and 300 μm, respectively. The interval between the heater sections was 200 μm.

As material of the coil, not only Ni—Cr but also heat-generating metal line can be used. With adhering the coil to the optical fiber gratings closely, the inner diameter of the coil is suitably controlled along an optical fiber gratings. Each of coil sections are attached to a bottom with the heat-resistant silicon. The optical fiber can be permanently fixed by silicon or an optical fiber holder, thereby changing the properties of fiber gratings appropriately. An interval between the heating coils is controlled to make the heat distribution in the respective coil sections be equal. Thus, the grating sections can be individually controlled along the grating length corresponding to a use of the grating filter.

Long-period fiber gratings were fabricated by exposing B—Ge co-doped fibers to KrF excimer laser through an amplitude mask. The grating periods an d length L of long-period fiber gratings were 423 μm and 61.4 mm, respectively.

The divided coil heaters are composed of individually controllable 20 coil heater sections. The controller adjusts an electric power of each coil heater section individually to make the appropriate temperature distribution along the grating. The uniform long-period fiber grating is divided by 20 piecewise-uniform grating sections; therefore the line shape of its transmission spectra can be modified as desired.

The divided coil heaters have three benefits: 1) individual control of each section along the gratings; 2) symmetrical heating of the cylindrical shaped fiber; and 3) high tuning efficiency.

The band rejection filters using the optical fiber gratings of the present invention have various shapes of loss curve, precise filter characteristics, and simple schematics. Thus, the band rejection filters can be applied to gain-flattening of EDFA.

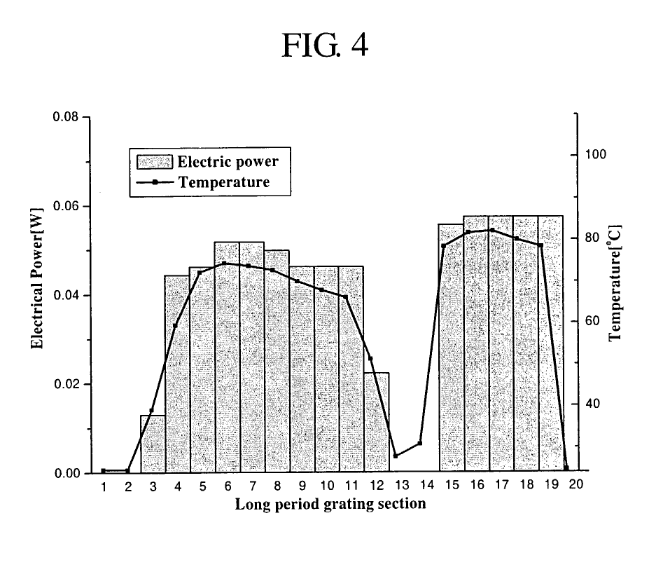

FIG. 4 shows the transmission spectrum of the LP₀₄ cladding mode before and after thermal tuning of long-period fiber gratings. In general, long-period fiber gratings are very useful for applications to gain-flattening of EDFA due to their wide bandwidth and leaky mode characteristics. However, the desired frequency response curve is the inverted gain spectrum of a commercially available EDFA gain spectrum (Gray thick line). The appropriate temperature distribution along the grating changes the peak wavelength, the peak depth, and the spectral shape of the uniform long-period fiber grating (dot line) to achieve the desired filter shape (solid thin line).

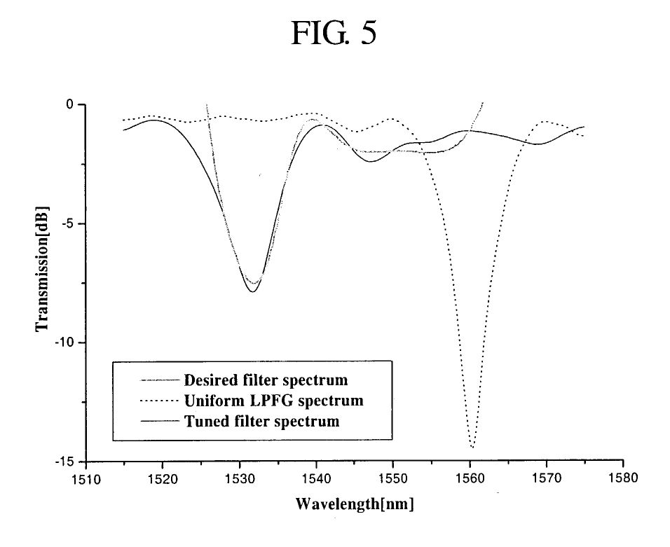

FIG. 5 shows the experimental of EDFA gain spectrum before and after tuning of the gain-flattening filter. The solid and gray thick lines show the EDFA gain curve and flattened spectrum with the proposed filter, respectively. A gain flatness of <1.1 dB is obtained over 33 nm wavelength range (gray thick line).

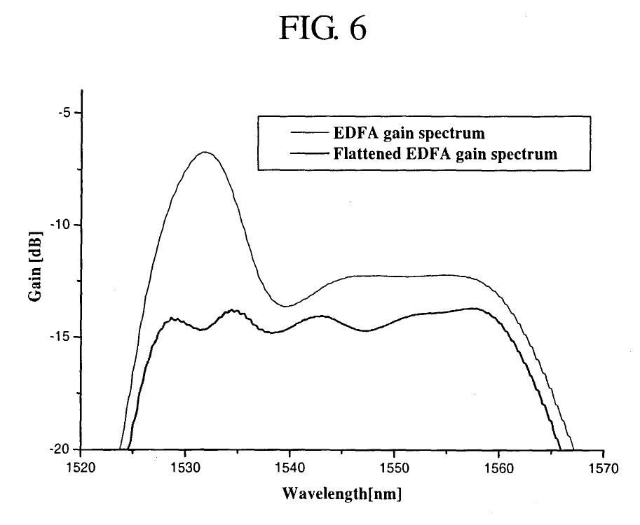

FIG. 6 shows the applied electrical power distribution along divided coil is heaters and measured temperature distribution along the optical fiber gratings. In the meantime, a cooling fan is attached to an upper portion of the coil heater to minimize thermal crosstalk of long-period grating sections and to maintain the peripheral temperature constantly.

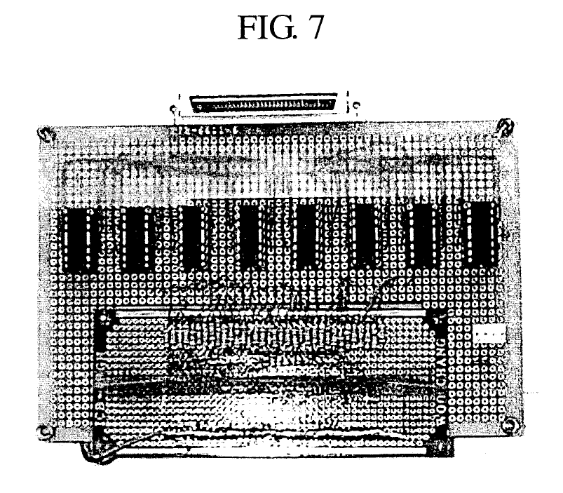

FIG. 7 shows the optical fiber grating with the coil heater, which is actually fabricated as mentioned in the present invention.

As aforementioned, the optical fiber grating according to the present invention easily controls the refractive index along each grating section thus to obtain a spectrum which is suitable for each kind of optical communications components. Accordingly, the present invention can be widely used as a multipurpose optical fiber band rejection filter or an EDFA gain flattening filter. Also, since the variation of a loss spectrum with the temperature change is fast, the present invention can be also applied to a dynamic EDFA gain flattening filter.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An optical fiber grating comprising:
Optic fiber having periodically formed gratings; and
The temperature control method for independently controlling temperature of the optical fiber along grating sections

2. The grating of claim 1, wherein the temperature control method is means is based on a coil heater wound on the optical fiber along grating sections.

3. The grating of claim 2, further comprising a cooling fan installed at an upper portion of the coil heater.

4. The grating of claim 2, wherein the coil heater is made of Ni—Cr coil.

5. An optical fiber device in optical communication using the optical fiber grating of claim 1.

6. A method for controlling an effective refractive index of an optical fiber grating, which can control the temperature distribution and the refractive index of optical fiber along grating sections individually.
